(19) United States
(12) Patent Application Publication
(10) Pub. No.: US 2026/0254299 A1
(43) Pub. Date: Aug. 27, 2026

(54) MOTOR

(71) Applicant: DENSO CORPORATION, Kariya-city (JP)

(72) Inventors: Takafumi NEGI, Kariya-city (JP); Takao YOSHIMOTO, Kariya-city (JP)

(73) Assignee: DENSO CORPORATION, Kariya-city (JP)

(21) Appl. No.: 19/467,382

(22) Filed: Feb. 2, 2026

Related U.S. Application Data
(63) Continuation of application No. PCT/JP2024/023541, filed on Jun. 28, 2024.

(30) Foreign Application Priority Data
Jul. 31, 2023 (JP) 2023-124595

(51) Int. Cl. H02K 1/276; H02K 21/16; H02K 29/03

(52) U.S. Cl. CPC H02K 1/276; H02K 21/16; H02K 29/03; H02K 2213/03

(57) ABSTRACT

A motor includes an annular stator having a plurality of teeth and windings wound on the teeth. Moreover, the motor also includes a rotor having a rotor core and a plurality of permanent magnets provided in the rotor core; the rotor also has a plurality of magnetic pole portions formed by the permanent magnets on a surface of the rotor core which faces the stator. At least some of the magnetic pole portions each have a groove recessed radially inward. In each of the at least some of the magnetic pole portions, the groove is formed symmetrically with respect to a circumferential center of the magnetic pole portion. Furthermore, the motor is configured to satisfy the relationship of 0.12 < Wg/(360/P) < 0.31, where Wg is the angle of the width of the groove at a radially outer end thereof, and P is the number of the magnetic pole portions.

### CROSS-REFERENCE TO RELATED APPLICATIONS

The present application is a continuation application of International Application No. PCT/JP2024/023541 filed on Jun. 28, 2024, which is based on and claims priority from Japanese Patent Application No. 2023-124595 filed on Jul. 31, 2023. The entire contents of these applications are incorporated by reference into the present application.

### BACKGROUND

### 1 Technical Field

The present disclosure relates to motors.

### 2 Description of Related Art

Motors used in apparatuses that require a position-holding function, such as motor-operated variable valve timing apparatuses, require high detent torque. Moreover, as a motor designed to improve detent torque, a motor has been proposed which has grooves formed on a surface of a rotor which faces a stator (see, for example, Japanese Patent Application Publication No. JP 2019-041530 A).

### SUMMARY

In the motor described above, detent torque can be improved by the grooves formed in the rotor. However, the inventors of the present application have been studying motor configurations which can cope with situations where higher detent torque is required.

According to a first aspect of the present disclosure, there is provided a motor comprising:

an annular stator having a plurality of teeth each extending toward a central axis and arranged in alignment with each other in a circumferential direction and windings wound on the teeth; and

a rotor having a rotor core rotatably accommodated inside the stator and a plurality of permanent magnets provided in the rotor core and arranged in alignment with each other in the circumferential direction, the rotor also having a plurality of magnetic pole portions formed by the plurality of permanent magnets on a surface of the rotor core which faces the stator and aligned with each other in the circumferential direction,

wherein:

at least some of the magnetic pole portions each have a groove recessed radially inward;

in each of the at least some of the magnetic pole portions, the groove is formed symmetrically in the circumferential direction with respect to a magnetic pole center which is a circumferential center of the magnetic pole portion; and

0.12 < Wg/(360/P) < 0.31, where Wg is an angle of a width of the groove at a radially outer end thereof, and P is the number of the magnetic pole portions.

According to the first aspect of the present disclosure, the motor is configured to satisfy the relationship of 0.12 < Wg/(360/P) < 0.31, where Wg is the angle of the width of the groove at the radially outer end thereof, and P is the number of the magnetic pole portions. Consequently, it becomes possible to secure high detent torque. Specifically, as shown in FIG. 4, satisfying the relationship of 0.12 < Wg/(360/P) < 0.31, higher detent torque can be obtained in comparison with the case of not satisfying the relationship of 0.12 < Wg/(360/P) < 0.31.

According to a second aspect of the present disclosure, there is provided a motor comprising:

an annular stator having a plurality of teeth each extending toward a central axis and arranged in alignment with each other in a circumferential direction and windings wound on the teeth; and

a rotor having a rotor core rotatably accommodated inside the stator and a plurality of permanent magnets provided in the rotor core and arranged in alignment with each other in the circumferential direction, the rotor also having a plurality of magnetic pole portions formed by the plurality of permanent magnets on a surface of the rotor core which faces the stator and aligned with each other in the circumferential direction,

wherein:

at least some of the magnetic pole portions each have a groove recessed radially inward or a hole having a shape recessed radially inward and closed at a radially outer end thereof; and

the motor is configured so that at a cogging peak position, the total torque generated by specific teeth, which are those of the plurality of teeth whose states of angles relative to the magnetic pole portions are identical, is within a range of 80% to 120% of cogging torque.

According to the second aspect of the present disclosure, the motor is configured so that at a cogging peak position, the total torque generated by specific teeth, which are those of the plurality of teeth whose states of angles relative to the magnetic pole portions are identical, is within the range of 80% to 120% of cogging torque. Consequently, it becomes possible to secure high detent torque.

### BRIEF DESCRIPTION OF THE DRAWINGS

FIG. 1 is a cross-sectional view of part of a motor according to an embodiment.

FIG. 2 is a plan view of part of the motor according to the embodiment.

FIG. 3 is an angle-torque characteristic diagram of the motor according to the embodiment.

FIG. 4 is a Wg/(360/P)-detent torque characteristic diagram of the motor according to the embodiment.

FIG. 5 is a Wg/(360/P)-average torque characteristic diagram of the motor according to the embodiment.

FIG. 6 is a Wk/(2×Wr+Wg)-detent torque characteristic diagram of the motor according to the embodiment.

FIG. 7 is a Z/G-detent torque characteristic diagram of the motor according to the embodiment.

FIG. 8 is a Wu/(360/P)-detent torque characteristic diagram of the motor according to the embodiment.

FIG. 9 is a Wu/(360/P)-average torque characteristic diagram of the motor according to the embodiment.

FIG. 10 is a Wk/(360/S)-detent torque characteristic diagram of the motor according to the embodiment.

FIG. 11 is a plan view of part of a motor according to a modification.

FIG. 12 is a Wa-detent torque characteristic diagram of the motor according to the modification shown in FIG. 11.

FIG. 13 is a plan view of part of a motor according to another modification.

FIG. 14 is a Wb-detent torque characteristic diagram of the motor according to the modification shown in FIG. 13.

FIG. 15 is a Wb-average torque characteristic diagram of the motor according to the modification shown in FIG. 13.

FIG. 16 is a plan view of part of a motor according to another modification.

FIG. 17 is a (2×Wr1+Wg)/(2×Wr2+Wg)-average torque characteristic diagram of the motor according to the modification shown in FIG. 16.

FIG. 18 is a (2×Wr1+Wg)/(2×Wr2+Wg)-detent torque characteristic diagram of the motor according to the modification shown in FIG. 16.

FIG. 19 is an angle-torque characteristic diagram of the motor according to the modification shown in FIG. 16.

FIG. 20 is a (2×Wr1+Wg)/(2×Wr2+Wg)-ripple rate characteristic diagram of the motor according to the modification shown in FIG. 16.

FIG. 21 is a plan view of part of a motor according to another modification.

FIG. 22 is a plan view of part of a motor according to another modification.

FIG. 23 is a (Wgs-Wg)-average torque characteristic diagram of the motor according to the modification shown in FIG. 22.

FIG. 24 is a plan view of part of a motor according to another modification.

FIG. 25 is a plan view of part of a motor according to another modification.

FIG. 26 is a plan view of part of a motor according to another modification.

### DESCRIPTION OF EMBODIMENTS

Hereinafter, an embodiment of a motor will be described with reference to the drawings. It should be noted that in the drawings, for the sake of convenience of explanation, some parts are shown in an exaggerated or simplified manner. Moreover, it also should be noted that some ratios between dimensions of parts shown in the drawings are different from the actual ratios.

### Configuration of Motor 10

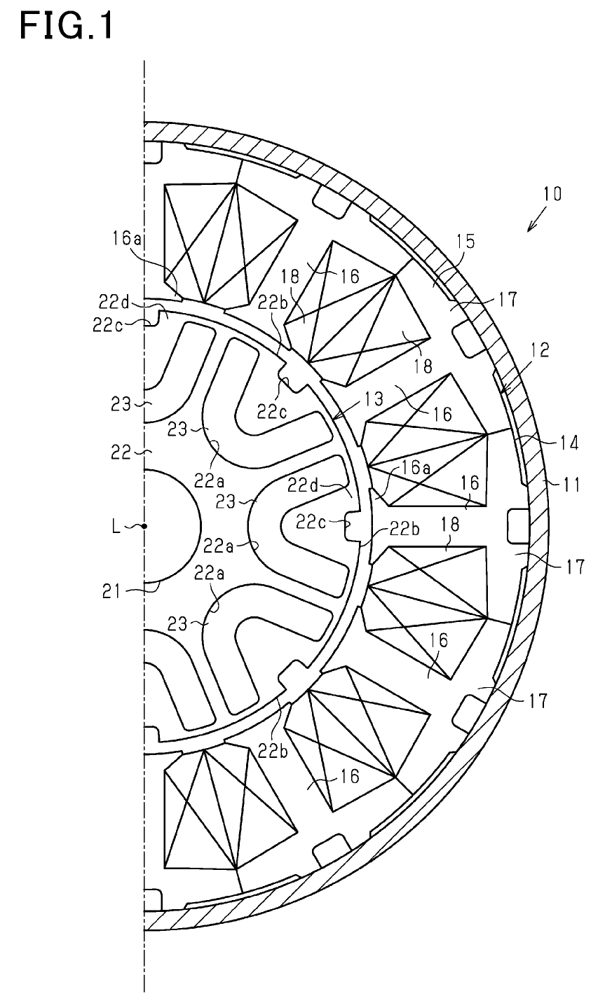

As shown in FIG. 1, a motor 10 according to the present embodiment is an interior permanent magnet brushless motor. The motor 10 includes an annular stator 12 fixed to an inner circumferential surface of a motor housing 11, and a rotor 13 rotatably accommodated inside the stator 12.

### Configuration of Stator 12

The stator 12 has a cylindrical stator core 14; and an outer circumferential surface of the stator core 14 is fixed to the motor housing 11. The stator core 14 has an annular part 15 and a plurality of teeth 16 that extend from the annular part 15 radially inward, i.e., toward a central axis L, and are arranged in alignment with each other in a circumferential direction. In addition, in the present embodiment, the outer diameter of the stator core 14 is set to 55mm.

The teeth 16 are arranged at equal angular intervals. More particularly, in the present embodiment, the stator core 14 has twelve teeth 16. That is, in the present embodiment, the number of slots of the stator 12, which is equal to the number of the teeth 16, is 12. Moreover, in the present embodiment, the stator core 14 is constituted of a plurality of core segments 17 such that the annular part 15 is segmented for each tooth 16. It should be noted that: in the stator core 14, insulators are assembled respectively to the core segments 17; however, in the drawing, the stator core 14 is shown schematically omitting the insulators.

Each of the teeth 16 has, at a radially inner end thereof, an umbrella portion 16a that protrudes toward both sides in the circumferential direction. Moreover, radially inner end surfaces of the teeth 16, more specifically, radially inner end surfaces of the umbrella portions 16a of the teeth 16 are formed as arc-shaped surfaces whose centers are on the central axis L.

The stator 12 also has windings 18 of three phases wound around the teeth 16. Specifically, the windings 18 are wound around the respective teeth 16 in a concentrated winding manner so as to be arranged between the teeth 16. The stator 12 generates a rotating magnetic field with three-phase drive current supplied to the windings 18.

### Configuration of Rotor 13

The rotor 13 has a rotating shaft 21 provided in such as manner as to be rotatable about the central axis L, a rotor core 22 fixed to an outer periphery of the rotating shaft 21, and a plurality of permanent magnets 23 provided in the rotor core 22 and arranged in alignment with each other in the circumferential direction. The rotating shaft 21 may be rotatably supported, for example, by end housings (not shown) via bearings (not shown).

The rotor core 22 is formed by laminating a plurality of discoid magnetic steel plates in the axial direction. The thickness of the magnetic steel sheets may be set to be, for example, in the range of 0.25mm to 0.7mm. More particularly, in the present embodiment, magnetic steel sheets having a thickness of 0.5mm are employed for the rotor core 22. Moreover, in the present embodiment, the outer diameter of the rotor core 22 is set to 30.8mm.

The rotor core 22 has a plurality of magnet-receiving portions 22a arranged in alignment with each other in the circumferential direction. In the present embodiment, each of the magnet-receiving portions 22a is formed in a U-shape that is open radially outward. It should be noted that the term “U-shape” used here denotes a shape which is curved in a rounded manner on the radially inner side when viewed in the axial direction. More specifically, in the present embodiment, each of the magnet-receiving portions 22a is formed in a shape such that two end portions of the magnet-receiving portion 22a become further separated from each other as they approach distal ends thereof. Moreover, the magnet-receiving portions 22a are provided at equal angular intervals. More particularly, in the present embodiment, the rotor core 22 has eight magnet-receiving portions 22a formed therein.

The permanent magnets 23 are received and arranged respectively in the magnet-receiving portions 22a of the rotor core 22. In the present embodiment, the permanent magnets 23 are implemented by samarium-iron-based bonded magnets, and arranged to fill the respective magnet-receiving portions 22a. That is, the permanent magnets 23 have the same shape as the magnet-receiving portions 22a, and are arranged in a U-shape that is open radially outward. Consequently, on a surface of the rotor core 22 which faces the stator 12, there are formed, by the permanent magnets 23, a plurality of magnetic pole portions 22b that are aligned with each other in the circumferential direction. In addition, in the present embodiment, the rotor 13 is of an interior permanent magnet type such that: the permanent magnets 23 are arranged respectively in the magnetic pole portions 22b; and the number of the magnetic pole portions 22b and the number of the permanent magnets 23 are equal to each other. That is, in the present embodiment, the number of magnetic poles of the rotor 13, which is equal to the number of the magnetic pole portions 22b, is 8.

### Detailed Configuration of Grooves 22c

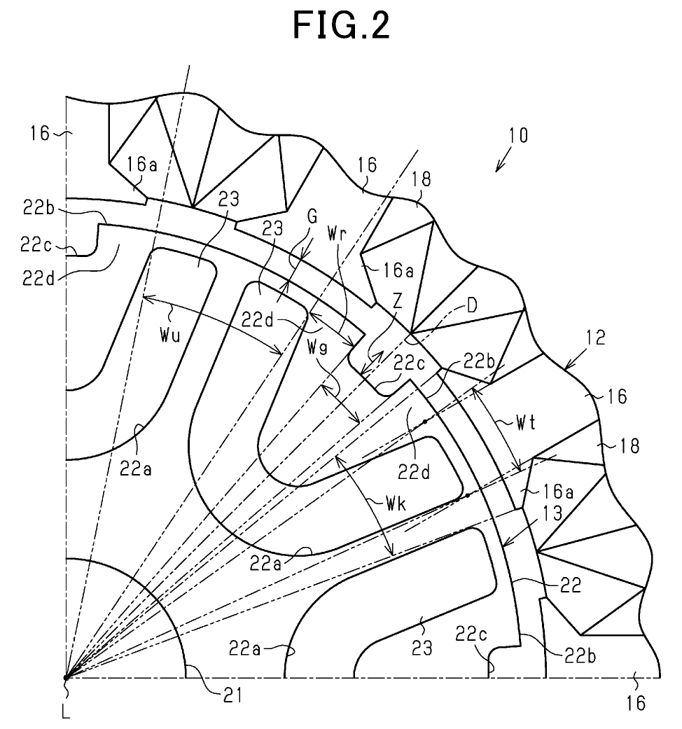

As shown in FIG. 2, each of the magnetic pole portions 22b has a groove 22c recessed radially inward. In other words, the rotor core 22 has, for each of the magnetic pole portions 22b, a groove 22c recessed radially inward. In each of the magnetic pole portions 22b, the groove 22c is formed symmetrically in the circumferential direction with respect to a magnetic pole center which is a circumferential center of the magnetic pole portion 22b. More specifically, the groove 22c is formed symmetrically with respect to the d axis which is represented by a straight line D that extends radially through the circumferential center of the magnetic pole portion 22b. Moreover, the groove 22c is formed over the entire axial length of the rotor core 22. Furthermore, the groove 22c has a constant width between a pair of circumferential end surfaces thereof. In addition, radially outer end portions of the groove 22c are not chamfered with respect to an outer circumferential surface of the rotor core 22, and are formed as a so-called pin angle.

In the present embodiment, the motor 10 is configured to satisfy the following relationship: 0.12 < Wg/(360/P) < 0.31, where Wg is the angle of the width of each of the grooves 22c at a radially outer end thereof, and P is the number of the magnetic pole portions 22b. In addition, the unit of Wg is “°” (i.e., degree). It should be noted that the term “angle” used in the present embodiment denotes an angle centering on the central axis L, and more specifically, denotes an angle between auxiliary lines drawn from the central axis L to target positions. Further, in the present embodiment, the motor 10 is configured to satisfy the relationship of 0.12 < Wg/(360/P) < 0.27. Furthermore, in the present embodiment, the motor 10 is configured to satisfy the relationship of 0.15 < Wg/(360/P) < 0.27. More particularly, in the present embodiment, Wg is set to 7.8° and P is set to 8; thus, Wg/(360/P) is 0.17.

Moreover, in the present embodiment, the motor 10 is configured to satisfy the following relationship: 0.7 < Wk/(2×Wr+Wg) < 1.0, where Wk is the angle of the width of each of the teeth 16 at a radially inner end thereof, and Wr is the angle of the width of each of magnetic path portions 22d of the rotor core 22 which form a magnetic path on both the circumferential sides of each of the grooves 22c. In addition, the units of Wk and Wr are “°” (i.e., degree). More particularly, in the present embodiment, Wk is set to 19.5° and (2×Wr+Wg) is set to 24.0°; thus, Wk/(2×Wr+Wg) is 0.81.

Furthermore, in the present embodiment, the motor 10 is configured to satisfy the following relationship: 0.5×Wt < Wr < Wt, where Wt is the angle of a minimum width of each of the teeth 16 defined at the same radial position as the magnetic path portions 22d of the rotor core 22.

Furthermore, in the present embodiment, the motor 10 is configured to satisfy the following relationship: Z/G ≥ 0.75, where G is the length of an air gap between the teeth 16 of the stator core 14 and the rotor core 22, and Z is the radial depth of each of the grooves 22c. In addition, the units of G and Z are “mm”. More particularly, in the present embodiment, G is set to 0.55mm and Z is set to 1.15mm; thus, Z/G is 2.1.

Furthermore, in the present embodiment, the motor 10 is configured to satisfy the following relationship: 0.44 < Wu/(360/P) < 0.58, where Wu is the angle of a width including end portions of a circumferentially-adjacent pair of the permanent magnets 23. In addition, the unit of Wu is “°” (i.e., degree). More particularly, in the present embodiment, Wu is set to 21.0°; thus, Wu/(360/P) is 0.47.

Furthermore, in the present embodiment, the motor 10 is configured to satisfy the following relationship: 0.57 < Wk/(360/S) < 0.78 is satisfied, where Wk is the angle of the width of each of the teeth 16 at a radially inner end thereof, and S is the number of the teeth 16. More particularly, in the present embodiment, Wk is set to 19.5° and S is set to 12; thus, Wk/(360/S) is 0.65.

Furthermore, in the present embodiment, the motor 10 is configured so that at a cogging peak position, the total torque generated by specific teeth 16, which are those of the teeth 16 whose states of angles relative to the magnetic pole portions 22b are identical, is within the range of 80% to 120% of the cogging torque. In addition, this configuration is realized by the configurations and shapes of the stator 12 and the rotor 13 described above.

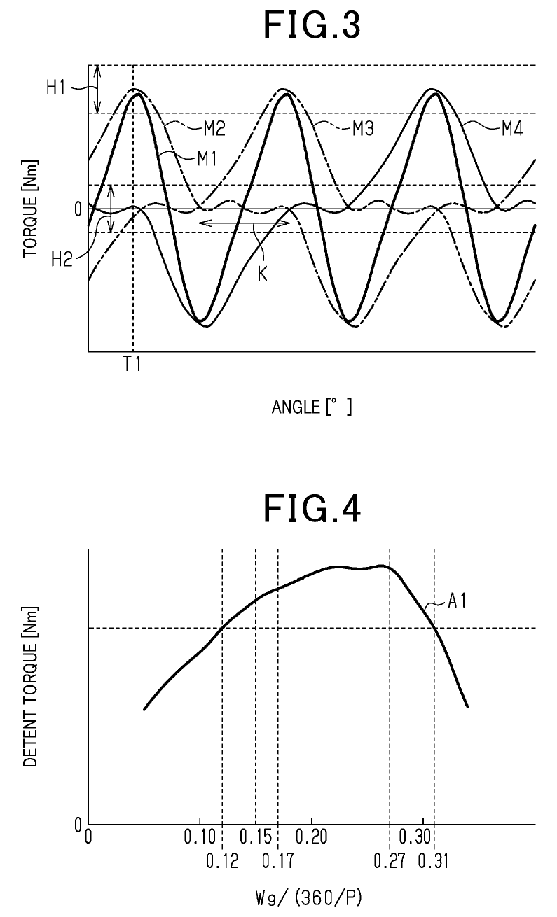

Specifically, as shown in FIG. 3, the motor 10 generates torque of a characteristic M1 as a whole. In the present embodiment, the number of slots is set to 12 and the number of magnetic poles is set to 8; therefore, the motor 10 generates the toque of the characteristic M1 that pulsates 24 times per revolution of the rotor 13, in other words, has a waveform whose one cycle is 15°. Moreover, the stator 12 as a whole has three sets of teeth 16; each set consists of four teeth 16 whose states of angles relative to the magnetic pole portions 22b are identical and which are spaced at intervals of 90°. The three sets of teeth 16 respectively generate torques of characteristics M2, M3 and M4. At an angle T1, which is a cogging peak position, the torque of the characteristic M2 generated by a specific set of teeth 16 is within the range H1 of 80% to 120% of the cogging torque which is the maximum value of the characteristic M1.

Moreover, in the present embodiment, the motor 10 is configured so that at the cogging peak position, the total torque generated by specific teeth 16 is equal to the cogging torque. That is, in the present embodiment, the motor 10 is configured so that at the cogging peak position, the total torque generated by specific teeth 16 and the cogging torque are substantially equal to each other. In other words, in the motor 10 according to the present embodiment, the configurations and shapes of the stator 12 and the rotor 13 are set so that at the cogging peak position, the total torque generated by specific teeth 16 and the cogging torque are as close as possible to each other. Furthermore, in the present embodiment, the motor 10 is configured so that at the cogging peak position, the total torque generated by specific teeth 16, which are those of the teeth 16 whose states of angles relative to the magnetic pole portions 22b are identical, is within the range of 90% to 110% of the cogging torque.

Moreover, in the present embodiment, the motor 10 is configured so that at the cogging peak position, the total torque generated by those of the teeth 16 other than the specific teeth 16 is within the range of -20% (i.e., minus 20%) to +20% of the cogging torque.

Specifically, at the angle T1, which is the cogging peak position, the sum of the torques of the characteristics M3 and M4 generated respectively by the two sets of teeth 16 other than the specific set of teeth 16 is within the range H2 of -20% to +20% of the cogging torque.

Furthermore, in the present embodiment, the motor 10 is configured so that there is an interval where the torque generated by one of the teeth 16 remains at zero. It should be noted that the interval where the torque remains at zero is not limited to an interval where the torque remains strictly at zero, but encompasses an interval where the torque remains substantially at zero, for example an interval where the torque changes in small waves less than 1/10 of the maximum torque value. In FIG. 3, there is shown, as an example, an interval K where the torque of the characteristic M2 remains at zero. In addition, the torque of the characteristic M2 is generated by four teeth 16; and the torque generated by each of the four teeth 16 is 1/4 of the torque of the characteristic M2 at each angle.

Next, operation of the motor 10 according to the present embodiment will be described.

Upon supply of three-phase drive current to the windings 18 of the stator 12, a rotating magnetic field is generated in the stator 12. The rotating magnetic field causes the rotor 13 to rotate. Moreover, upon interruption of the supply of the three-phase drive current to the windings 18, the rotating magnetic field disappears, causing the rotor 13 to stop. At this time, the rotor 13 stops at an angular position where it is brought into a magnetically stable state relative to the stator 12. In this state, detent torque acts on the rotor 13.

Next, advantageous effects achievable according to the present embodiment will be described.

(1) In the present embodiment, each of the magnetic pole portions 22b has a groove 22c recessed radially inward; and the groove 22c is formed symmetrically in the circumferential direction with respect to the magnetic pole center which is the circumferential center of the magnetic pole portion 22b. Moreover, the motor 10 is configured to satisfy the following relationship: 0.12 < Wg/(360/P) < 0.31, where Wg is the angle of the width of each of the grooves 22c at the radially outer end thereof, and P is the number of the magnetic pole portions 22b. Consequently, it becomes possible to secure high detent torque. Specifically, with the grooves 22c formed in the magnetic pole portions 22b, it becomes possible to increase change in magnetic flux density in the circumferential direction in the air gap between the teeth 16 of the stator core 14 and the rotor core 22, thereby securing high detent torque.

More specifically, as shown in FIG. 4, satisfying the relationship of 0.12 < Wg/(360/P) < 0.31, higher detent torque can be obtained in comparison with the case of not satisfying the relationship of 0.12 < Wg/(360/P) < 0.31. It should be noted that the characteristic A1 shown in FIG. 4 is a waveform obtained by experiment or computation, and indicates the change in detent torque with change in Wg/(360/P).

Moreover, as shown in FIG. 5, satisfying the relationship of 0.12 < Wg/(360/P) < 0.31, high average torque can be obtained. It should be noted that the characteristic A2 shown in FIG. 5 is a waveform obtained by experiment or computation, and indicates the change in average torque with change in Wg/(360/P).

(2) In the present embodiment, the motor 10 is configured to satisfy the relationship of 0.12 < Wg/(360/P) < 0.27. Consequently, it becomes possible to secure higher average torque while securing higher detent torque. Specifically, as shown in FIG. 5, satisfying the relationship of 0.12 < Wg/(360/P) < 0.27, higher average torque can be obtained in comparison with the case of not satisfying the relationship of 0.12 < Wg/(360/P) < 0.27.

Furthermore, in the present embodiment, Wg/(360/P) is set to 0.17, and thus satisfies the relationship of 0.15 < Wg/(360/P) < 0.27. As such, the relationship of 0.15 < Wg/(360/P) < 0.27 is satisfied, thereby making it possible to secure higher detent torque as shown in FIG. 4.

(3) In the present embodiment, the motor 10 is configured to satisfy the following relationship: 0.7 < Wk/(2×Wr+Wg) < 1.0, where Wk is the angle of the width of each of the teeth 16 at the radially inner end thereof, and Wr is the angle of the width of each of the magnetic path portions 22d of the rotor core 22 which form the magnetic path on both the circumferential sides of each of the grooves 22c. Consequently, it becomes possible to secure high detent torque.

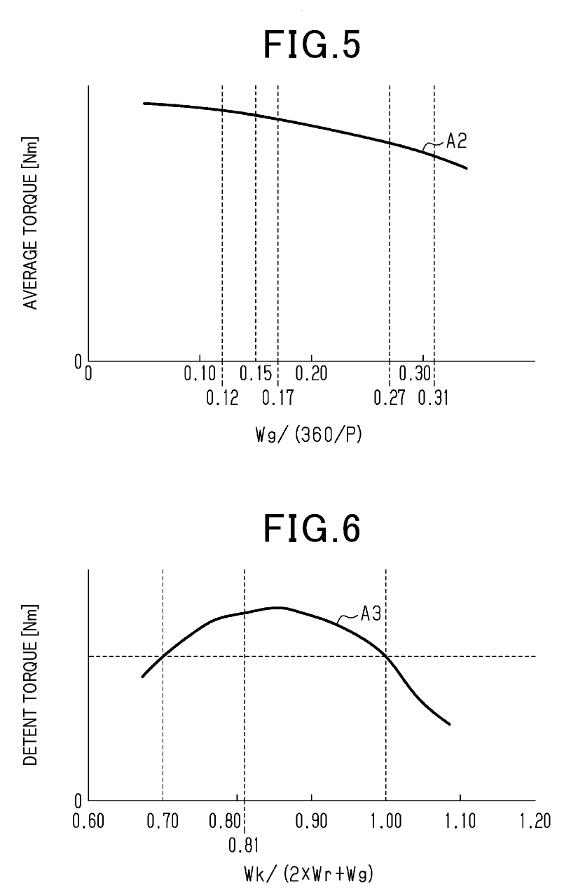

Specifically, as shown in FIG. 6, satisfying the relationship of 0.7 < Wk/(2×Wr+Wg) < 1.0, higher detent torque can be obtained in comparison with the case of not satisfying the relationship of 0.7 < Wk/(2×Wr+Wg) < 1.0. It should be noted that the characteristic A3 shown in FIG. 6 is a waveform obtained by experiment or computation, and indicates the change in detent torque with change in Wk/(2×Wr+Wg).

(4) In the present embodiment, the motor 10 is configured to satisfy the following relationship: 0.5×Wt < Wr < Wt, where Wr is the angle of the width of each of the magnetic path portions 22d of the rotor core 22 which form the magnetic path on both the circumferential sides of each of the grooves 22c, and Wt is the angle of the minimum width of each of the teeth 16 defined at the same radial position as the magnetic path portions 22d of the rotor core 22. Consequently, it becomes possible to secure high detent torque while suppressing decrease in average torque due to magnetic saturation of the magnetic path portions 22d.

(5) In the present embodiment, the motor 10 is configured to satisfy the following relationship: Z/G ≥ 0.75, where G is the length of the air gap between the teeth 16 of the stator core 14 and the rotor core 22, and Z is the radial depth of each of the grooves 22c. Consequently, it becomes possible to suppress leakage magnetic flux in the grooves 22c, thereby concentrating magnetic flux on the magnetic path portions 22d, increasing change in magnetic flux density in the circumferential direction in the air gap and thus securing high detent torque.

Specifically, as shown in FIG. 7, satisfying the relationship of Z/G ≥ 0.75, higher detent torque can be obtained in comparison with the case of not satisfying the relationship of Z/G ≥ 0.75. It should be noted that the characteristic A4 shown in FIG. 7 is a waveform obtained by experiment or computation, and indicates the change in detent torque with change in Z/G. Moreover, satisfying the relationship of Z/G ≥ 1.0, it is possible to secure higher detent torque and suppress variation in the detent torque. Furthermore, satisfying the relationship of Z/G ≥ 1.5, it is possible to secure even higher detent torque and further suppress variation in the detent torque.

(6) In the present embodiment, the permanent magnets 23, which are provided respectively in the magnetic pole portions 22b, are arranged in a U-shape that is open radially outward. Consequently, it becomes possible to easily secure spaces for forming the grooves 22c. Specifically, in the case of the permanent magnets 23 being arranged in an I-shape extending in a direction perpendicular to the radial direction, it may be difficult to secure spaces for forming the grooves 22c; compared to this case, it becomes easier, by arranging the permanent magnets 23 as in the present embodiment, to form the grooves 22c in the magnetic pole portions 22b.

(7) In the present embodiment, the motor 10 is configured to satisfy the following relationship: 0.44 < Wu/(360/P) < 0.58, where P is the number of the magnetic pole portions 22b, and Wu is the angle of a width including end portions of a circumferentially-adjacent pair of the permanent magnets 23. Consequently, it becomes possible to secure high average torque while securing high detent torque.

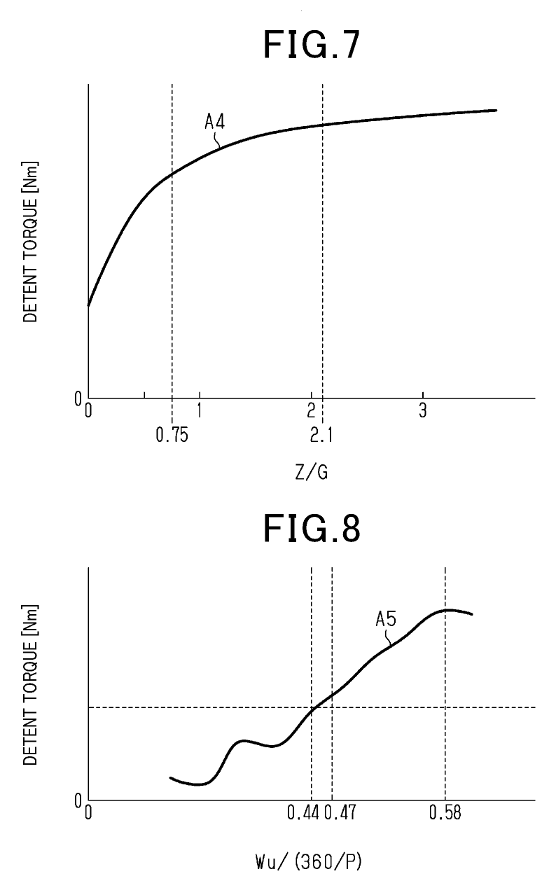

Specifically, as shown in FIG. 8, satisfying the relationship of 0.44 < Wu/(360/P) < 0.58, higher detent torque can be obtained in comparison with the case of not satisfying the relationship of 0.44 < Wu/(360/P) < 0.58. It should be noted that the characteristic A5 shown in FIG. 8 is a waveform obtained by experiment or computation, and indicates the change in detent torque with change in Wu/(360/P).

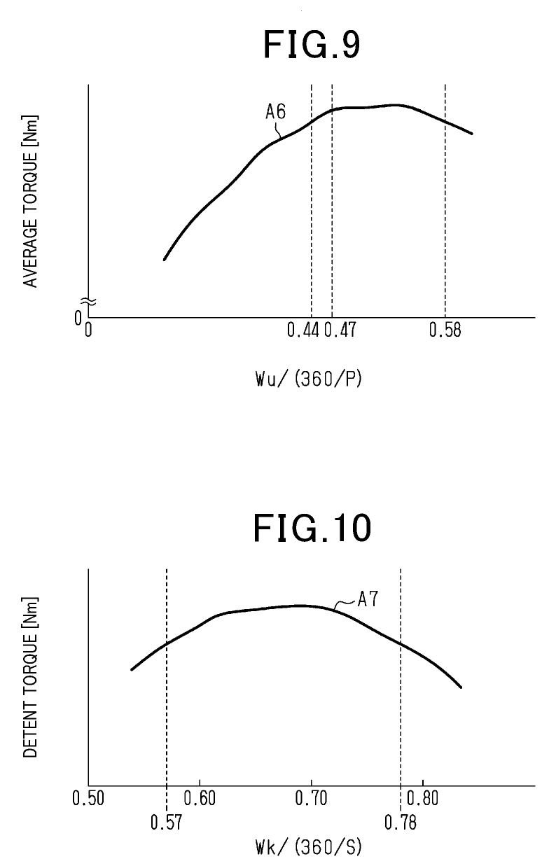

Moreover, as shown in FIG. 9, satisfying the relationship of 0.44 < Wu/(360/P) < 0.58, higher average torque can be obtained in comparison with the case of not satisfying the relationship of 0.44 < Wu/(360/P) < 0.58. It should be noted that the characteristic A6 shown in FIG. 9 is a waveform obtained by experiment or computation, and indicates the change in average torque with change in Wu/(360/P).

(8) In the present embodiment, the motor 10 is configured to satisfy the following relationship: 0.57 < Wk/(360/S) < 0.78 is satisfied, where Wk is the angle of the width of each of the teeth 16 at the radially inner end thereof, and S is the number of the teeth 16. Consequently, it becomes possible to secure high detent torque.

Specifically, as shown in FIG. 10, satisfying the relationship of 0.57 < Wk/(360/S) < 0.78, higher detent torque can be obtained in comparison with the case of not satisfying the relationship of 0.57 < Wk/(360/S) < 0.78. It should be noted that the characteristic A7 shown in FIG. 10 is a waveform obtained by experiment or computation, and indicates the change in detent torque with change in Wk/(360/S).

(9) In the present embodiment, the motor 10 is configured so that at a cogging peak position, the total torque generated by specific teeth 16, which are those of the teeth 16 whose states of angles relative to the magnetic pole portions 22b are identical, is within the range H1 of 80% to 120% of the cogging torque. Consequently, high detent torque can be obtained. In addition, higher detent torque can be obtained by configuring the motor 10 so that at the cogging peak position, the total torque generated by the specific teeth 16 is equal to the cogging torque.

(10) In the present embodiment, the motor 10 is configured so that at the cogging peak position, the total torque generated by those of the teeth 16 other than the specific teeth 16 is within the range H2 of -20% to +20% of the cogging torque. Consequently, high detent torque can be obtained.

(11) In the present embodiment, the motor 10 is configured so that there is an interval where the torque generated by one of the teeth 16 remains at zero. Consequently, high detent torque can be obtained. It should be noted that the above advantageous effects (9) to (11) are achievable by the rotor 13 according to the present embodiment. For example, for a motor specification where the stator 12 has grooves formed therein, it is necessary to calculate the advantageous effects achievable by the rotor 13 with the stator 12 set to a state of having no grooves.

(12) In the present embodiment, the motor 10 is configured to satisfy the following relationship: 0.57 < Wk/(360/S) < 0.78 is satisfied, where Wk is the angle of the width of each of the teeth 16 at the radially inner end thereof, and S is the number of the teeth 16. Consequently, it becomes possible to secure high detent torque.

Specifically, as shown in FIG. 10, satisfying the relationship of 0.57 < Wk/(360/S) < 0.78, higher detent torque can be obtained in comparison with the case of not satisfying the relationship of 0.57 < Wk/(360/S) < 0.78. It should be noted that the characteristic A7 shown in FIG. 10 is a waveform obtained by experiment or computation, and indicates the change in detent torque with change in Wk/(360/S).

The present embodiment may be modified and implemented as follows. In addition, the present embodiment and the following modifications may also be implemented in combination with each other to the extent that there is no technical contradiction between them.

In the above-described embodiment, each of the grooves 22c has a constant width between a pair of circumferential end surfaces thereof. Alternatively, for each of the grooves, the pair of circumferential end surfaces of the groove may be inclined so that the width of the groove increases radially inward.

For example, the above-described embodiment may be modified as shown in FIG. 11. In this modification (see FIG. 11), for each of the grooves 31, the pair of circumferential end surfaces 31a of the groove 31 are inclined so that the width of the groove 31 increases radially inward. Consequently, it becomes possible to secure higher detent torque. Specifically, by inclining the circumferential end surfaces 31a, it becomes possible to better control the flow of magnetic flux in the magnetic path portions 22d, thereby making it possible to secure higher detent torque.

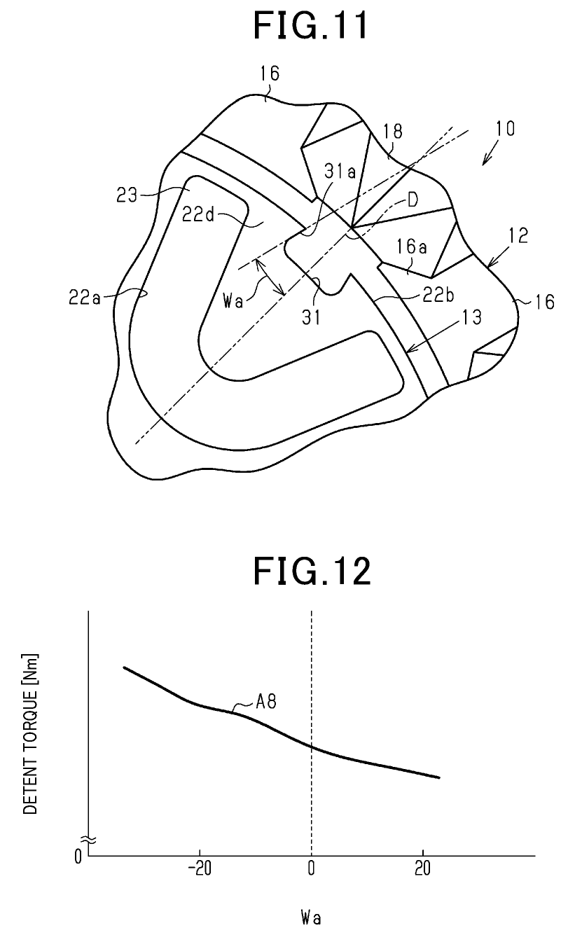

More specifically, as shown in FIG. 12, in the case of the pair of circumferential end surfaces 31a of each of the grooves 31 being inclined so that the width of each of the grooves 31 increases radially inward, higher detent torque can be obtained than in other cases. It should be noted that the characteristic A8 shown in FIG. 12 is a waveform obtained by experiment or computation, and indicates the change in detent torque with change in the angle Wa at which the pair of circumferential end surfaces 31a of each of the grooves 31 is inclined with respect to the aforementioned straight line D (i.e., the d-axis). In addition, in FIG. 12, the angle Wa is defined to be negative when the pair of circumferential end surfaces 31a of each of the grooves 31 are inclined so that the width of each of the grooves 31 increases radially inward.

In the above-described embodiment, each of end portions of the permanent magnets 23 is shaped so as to recede from a corresponding one of the circumferential end surfaces of the grooves 22c as it extends radially outward. However, each of end portions of the permanent magnets may be shaped to have a thick portion that protrudes in a direction approaching the corresponding one of the circumferential end surfaces of the grooves 22c.

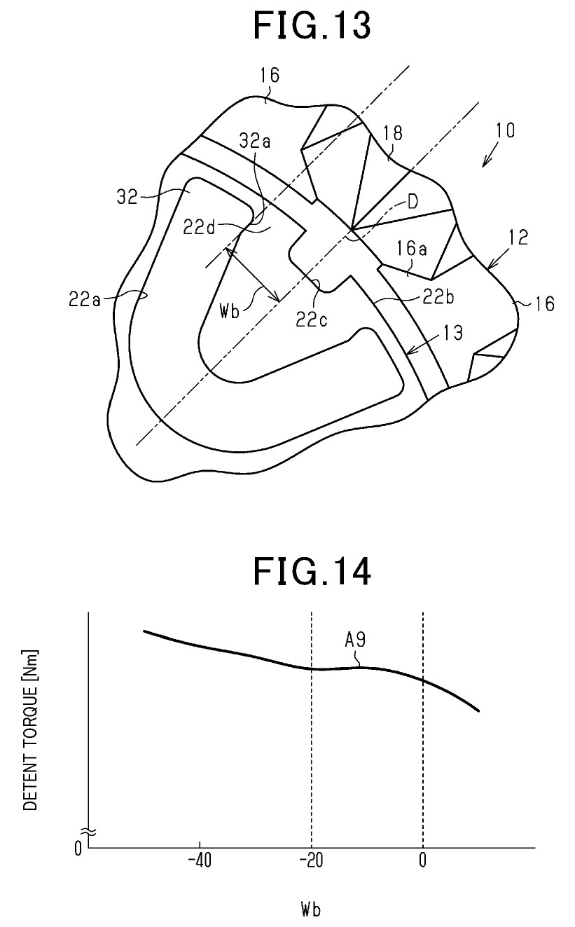

For example, the above-described embodiment may be modified as shown in FIG. 13. In this modification (see FIG. 13), each of end portions of the permanent magnets 32 is shaped so as to recede from a corresponding one of the circumferential end surfaces of the grooves 22c as it extends radially outward, and has a thick portion 32a that protrudes in a direction approaching the corresponding one of the circumferential end surfaces of the grooves 22c.

Consequently, it becomes possible to suppress leakage magnetic flux occurring in those portions of the rotor core 22 which are located radially outside the radially outer end surfaces of the permanent magnets 32, thereby securing high torque; and it also becomes possible to provide a width for pole switching, thereby increasing change in magnetic flux density in the circumferential direction in the air gap and thus securing both high detent torque and high average torque.

Specifically, as shown in FIG. 14, setting the angle Wb, at which the circumferential end surface of the thick portion 32a is inclined with respect to the aforementioned straight line D (i.e., the d-axis), to be less than equal to 0°, high detent torque can be secured. It should be noted that the characteristic A9 shown in FIG. 14 is a waveform obtained by experiment or computation, and indicates the change in detent torque with change in Wb. In addition, in FIG. 14, the angle Wb is defined to be negative when the circumferential end surface of the thick portion 32a becomes closer to the straight line D as it extends radially outward.

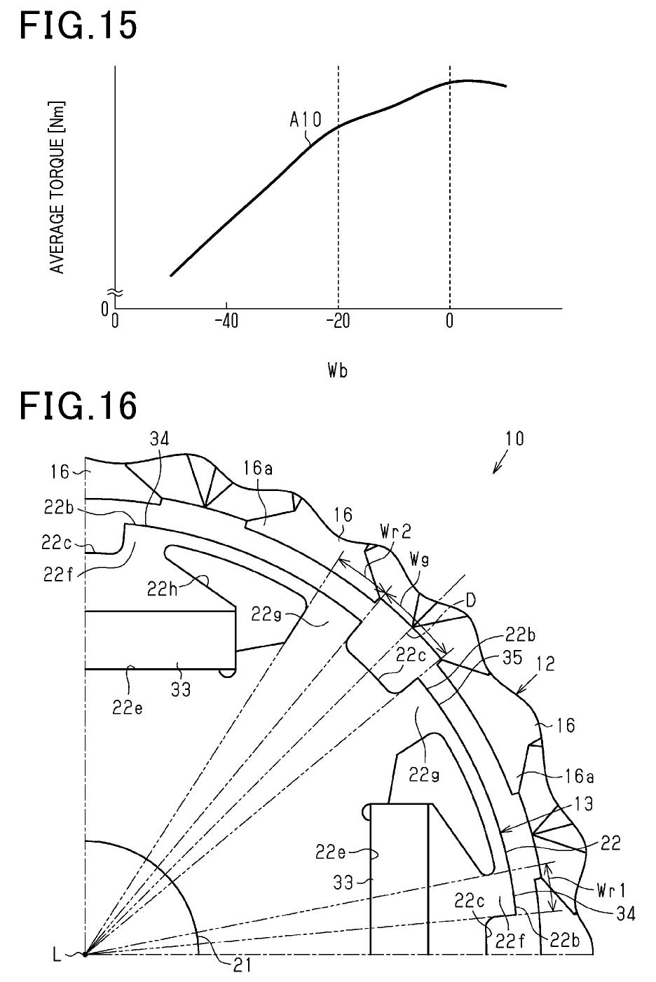

Moreover, as shown in FIG. 15, setting the angle Wb, at which the circumferential end surface of the thick portion 32a is inclined with respect to the aforementioned straight line D (i.e., the d-axis), to be within the range of −20° (i.e., minus 20°) to 0°, high average torque can be secured. It should be noted that the characteristic A10 shown in FIG. 15 is a waveform obtained by experiment or computation, and indicates the change in average torque with change in Wb. In addition, in FIG. 15, the angle Wb is defined to be negative when the circumferential end surface of the thick portion 32a becomes closer to the straight line D as it extends radially outward.

In the above-described embodiment, the rotor 13 is of an interior permanent magnet type such that the permanent magnets 23 are arranged respectively in the magnetic pole portions 22b. Alternatively, the rotor core 13 may be of a consequent pole type in which permanent magnets are arranged in every other magnetic pole portion in the circumferential direction.

For example, the above-described embodiment may be modified as shown in FIG. 16. In this modification (see FIG. 16), the rotor core 13 is of a consequent pole type in which permanent magnets 33 are arranged in every other magnetic pole portion 22b in the circumferential direction. The magnetic pole portions 22b include magnet magnetic-pole portions 34 each having a permanent magnet 33 arranged therein and non-magnet magnetic-pole portions 35 each having no permanent magnet 33 arranged therein; and the magnet magnetic-pole portions 34 and the non-magnet magnetic-pole portions 35 are arranged alternately in the circumferential direction.

In this modification, each of the magnet-receiving portions 22e of the rotor core 22 is formed in an I-shape extending in a direction perpendicular to the radial direction. Accordingly, the permanent magnets 33 received respectively in the magnet-receiving portions 22e are each arranged in an I-shape extending in a direction perpendicular to the radial direction.

In each of the magnet magnetic-pole portions 34, those parts of the rotor core 22 which form a magnetic path on both the circumferential sides of the groove 22c constitute magnet magnetic-path portions 22f. On the other hand, in each of the non-magnet magnetic-pole portions 35, those parts of the rotor core 22 which form a magnetic path on both the circumferential sides of the groove 22c constitute non-magnet magnetic-path portions 22g.

Moreover, in this modification, the rotor core 22 has flux barriers 22h which are air gaps for blocking magnetic flux. Specifically, in each of the magnet magnetic-pole portions 34, there are formed two flux barriers 22h so as to respectively communicate with two ends of the magnet-receiving portion 22e.

Furthermore, the flux barriers 22h are configured to satisfy the following relationship: (2×Wr1+Wg)/(2×Wr2+Wg) ≤ 1.5, where Wr1 is the angle of the width of each of the magnet magnetic-path portions 22f, and Wr2 is the angle of the width of each of the non-magnet magnetic-path portions 22g. More particularly, in this modification (see FIG. 16), (2×Wr1+Wg) is 21.8° and (2×Wr2+Wg) is 22.5°; thus, (2×Wr1+Wg)/(2×Wr2+Wg) is 0.97. Consequently, it becomes possible to secure high detent torque while securing high average torque. Moreover, it also becomes possible to suppress the ripple rate.

Specifically, as shown in FIG. 17, satisfying the relationship of (2×Wr1+Wg)/(2×Wr2+Wg) ≤ 1.5, high average torque can be obtained. It should be noted that the characteristic A11 shown in FIG. 17 is a waveform obtained by experiment or computation, and indicates the change in average torque with change in (2×Wr1+Wg)/(2×Wr2+Wg).

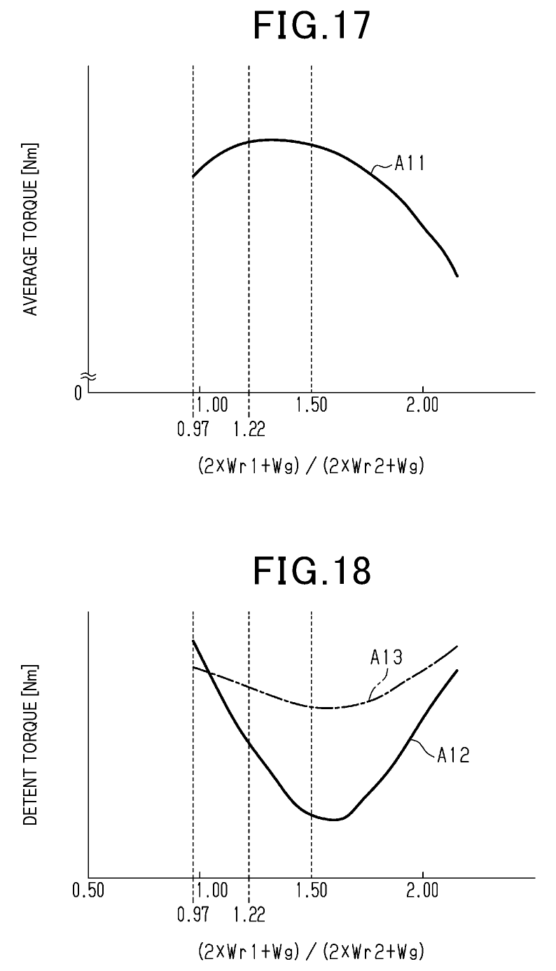

Moreover, as shown in FIG. 18, satisfying the relationship of (2×Wr1+Wg)/(2×Wr2+Wg) ≤ 1.5, high detent torque can be obtained. It should be noted that the characteristics A12 and A13 shown in FIG. 18 are waveforms obtained by experiment or computation, and indicate the change in detent torque with change in (2×Wr1+Wg)/(2×Wr2+Wg).

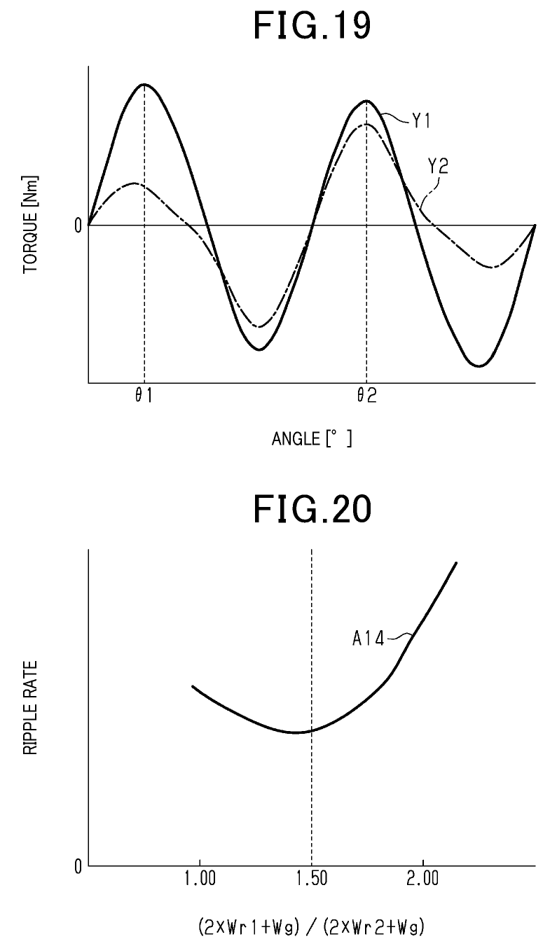

Furthermore, in this modification, since the motor 10 has both the magnet magnetic-pole portions 34 and the non-magnet magnetic-pole portions 35, two detent torque characteristics A12 and A13 are obtained according to the angle of the rotor 13. Specifically, as shown in FIG. 19, the torque characteristics Y1 and Y2 of the motor 10, which has both the magnet magnetic-pole portions 34 and the non-magnet magnetic-pole portions 35, have different peak values depending on the angles θ1 and θ2 of the rotor 13. The torque characteristic Y1 is the characteristic when (2×Wr1+Wg)/(2×Wr2+Wg) is 0.97 in this modification (see FIG. 16). On the other hand, the torque characteristic Y2 is the characteristic when (2×Wr1+Wg)/(2×Wr2+Wg) is 1.5. Moreover, the characteristic A12 indicates the change in detent torque with change in (2×Wr1+Wg)/(2×Wr2+Wg) in the case of the angle of the rotor 13 being θ1. On the other hand, the characteristic A13 indicates the change in detent torque with change in (2×Wr1+Wg)/(2×Wr2+Wg) in the case of the angle of the rotor 13 being θ2. Therefore, it is preferable to configure the motor 10 to satisfy, for example, the relationship of (2×Wr1+Wg)/(2×Wr2+Wg) ≤ 1.22. Consequently, it will become possible to reduce the difference between the flow of magnetic flux in the magnet magnetic-pole portions 34 and the flow of magnetic flux in the non-magnet magnetic-pole portions 35 in the consequent pole type rotor core 13, thereby making it possible to obtain high detent torque with small differences between the two characteristics A12 and A13. As a result, for example, the rotor 13 can be stably positioned and held at a small angle (e.g., 360°/24 in this modification). That is, the motor 10 can have high resolution. In addition, it is more preferable for (2×Wr1+Wg)/(2×Wr2+Wg) to be closer to 1 than 1.22 is.

Moreover, as shown in FIG. 20, configuring the motor 10 to satisfy the relationship of (2×Wr1+Wg)/(2×Wr2+Wg) ≤ 1.5, the ripple rate can be minimized. It should be noted that the characteristic A14 shown in FIG. 20 is a waveform obtained by experiment or computation, and indicates the change in ripple rate with change in (2×Wr1+Wg)/(2×Wr2+Wg).

Moreover, in this modification (see FIG. 16), Wr1 is used as Wr in the above-described relationship of 0.7 < Wk/(2×Wr+Wg) < 1.0; and Wk/(2×Wr+Wg) is set to 0.89. Furthermore, in this modification (see FIG. 16), Wr2, which is greater than Wr1, is used as Wr in the above-described relationship of 0.5×Wt < Wr < Wt.

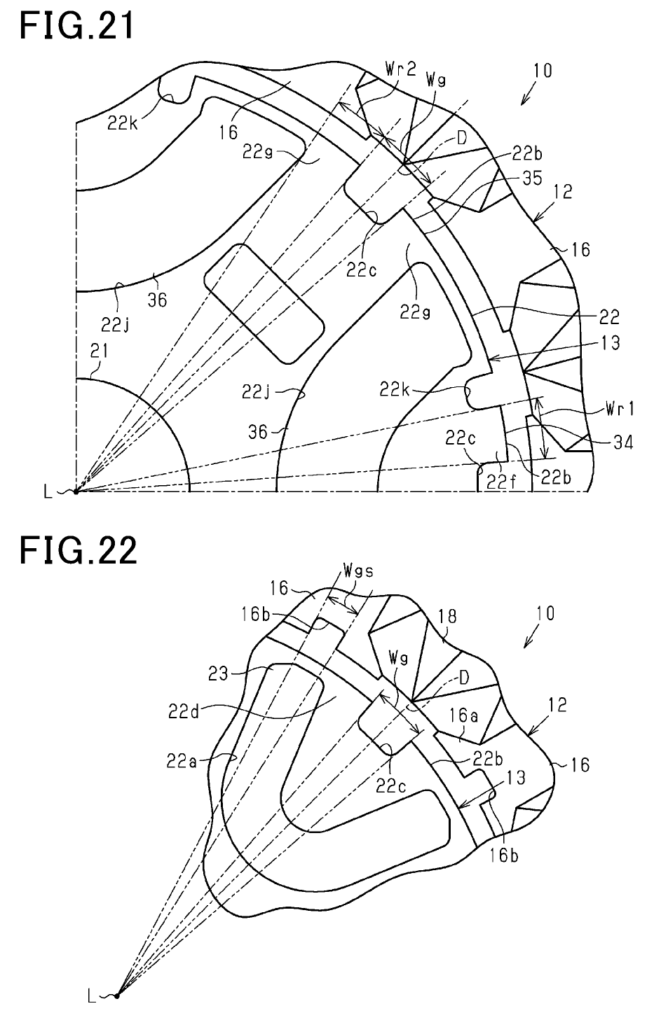

The above-described embodiment may also be modified as shown in FIG. 21. In this modification (see FIG. 21), the rotor core 13 is of a consequent pole type in which permanent magnets 36 are arranged in every other magnetic pole portion 22b in the circumferential direction. The magnetic pole portions 22b include magnet magnetic-pole portions 34 each having a permanent magnet 36 arranged therein and non-magnet magnetic-pole portions 35 each having no permanent magnet 36 arranged therein; and the magnet magnetic-pole portions 34 and the non-magnet magnetic-pole portions 35 are arranged alternately in the circumferential direction.

In this modification, the magnet-receiving portions 22j of the rotor core 22 are formed in a U-shape that is open radially outward. Moreover, the permanent magnets 36, which are received respectively in the magnet-receiving portions 22j, are arranged in a U-shape that is open radially outward.

Moreover, in this modification, the rotor core 22 has flux barriers 22k which are air gaps for blocking magnetic flux. The flux barriers 22k are formed separately from the magnet-receiving portions 22j and recessed radially inward from the outer circumferential surface of the rotor core 22.

Furthermore, the flux barriers 22k are configured to satisfy the following relationship: (2×Wr1+Wg)/(2×Wr2+Wg) ≤ 1.5, where Wr1 is the angle of the width of each of the magnet magnetic-path portions 22f, and Wr2 is the angle of the width of each of the non-magnet magnetic-path portions 22g. More particularly, in this modification (see FIG. 21), (2×Wr1+Wg) is 22.7° and (2×Wr2+Wg) is 21.0°; thus, (2×Wr1+Wg)/(2×Wr2+Wg) is 1.08. Consequently, it becomes possible to secure high detent torque while securing high average torque. Moreover, it also becomes possible to suppress the ripple rate.

In the above-described embodiment, the radially inner end surfaces of the teeth 16, more specifically, the radially inner end surfaces of the umbrella portions 16a of the teeth 16 are formed as simple arc-shaped surfaces. However, the radially inner end surfaces of the teeth 16 may have tooth grooves formed therein.

For example, as shown in FIG. 22, each of the teeth 16 may have a tooth groove 16b formed at a circumferential center in a radially inner end portion thereof so as to be recessed radially outward. In this case, higher detent torque can be secured.

In this modification, the motor 10 is configured to satisfy the following relationship: Wgs-Wg < 0, where Wgs is the angle of the width of each of the tooth grooves 16b at a radially inner end thereof. In addition, the unit of Wgs is “°” (i.e., degree). More particularly, in this modification (see FIG. 22), Wg is 8.2° and Wgs is 4.7°; thus, (Wgs-Wg) is -3.5°. Consequently, it becomes possible to secure high average torque.

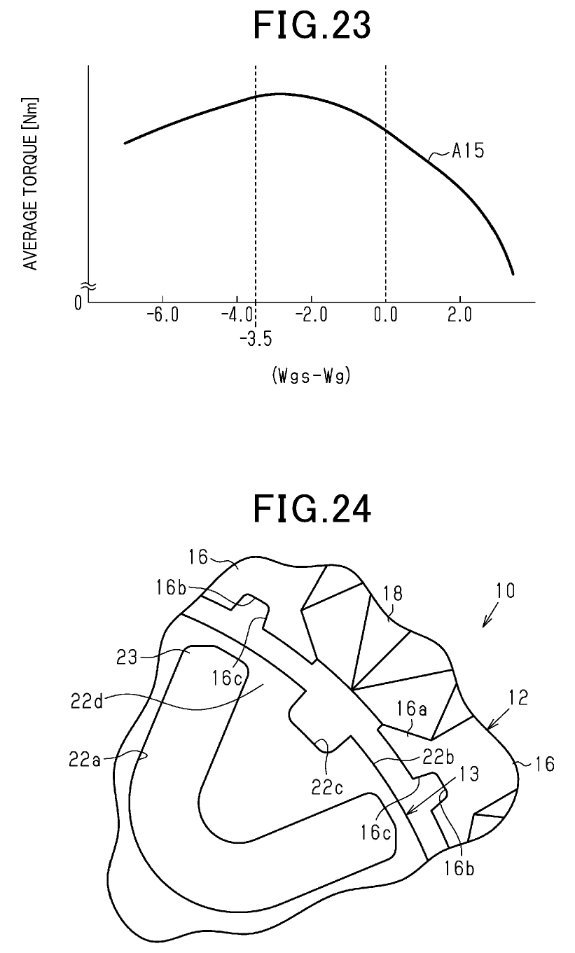

Specifically, as shown in FIG. 23, satisfying the relationship of Wgs-Wg < 0, high average torque can be obtained. It should be noted that the characteristic A15 shown in FIG. 23 is a waveform obtained by experiment or computation, and indicates the change in average torque with change in (Wgs-Wg).

Furthermore, as shown in FIG. 24, for each of the tooth grooves 16b, a pair of circumferential end surfaces 16c of the tooth groove 16b may be inclined so that the width of the tooth groove 16b decreases radially outward. Consequently, higher average torque can be secured.

In the above-described embodiment, the number of the grooves 22c is equal to the number of the magnetic pole portions 22b; and the grooves 22c are formed in the respective magnetic pole portions 22b. However, this configuration may be modified.

For example, as shown in FIG. 25, the number of the grooves 22c may be set to half the number of the magnetic pole portions 22b; and the grooves 22 may be formed in every other magnetic pole portion 22b in the circumferential direction. Specifically, for example, the grooves 22c may be formed in all of the magnetic pole portions 22b each constituting a north pole, but not in any of the magnetic pole portions 22b each constituting a south pole.

In the above-described embodiment, each of the magnet-receiving portions 22a is formed in a U-shape; and each of the permanent magnets 23 is arranged in a U-shape. Alternatively, each of the magnet-receiving portions 22a may be formed in a V-shape; and each of the permanent magnets 23 may be arranged in a V-shape. It should be noted that the term “V-shape” used here denotes a shape which is not curved on the radially inner side when viewed in the axial direction. In this case, for example, two permanent magnets each having a rectangular parallelepiped shape may be arranged together in a V shape. Moreover, in the above-described embodiment, the permanent magnets 23 are implemented by samarium-iron-based bonded magnets. Alternatively, the permanent magnets 23 may be implemented by, for example, rare earth sintered magnets such as neodymium magnets.

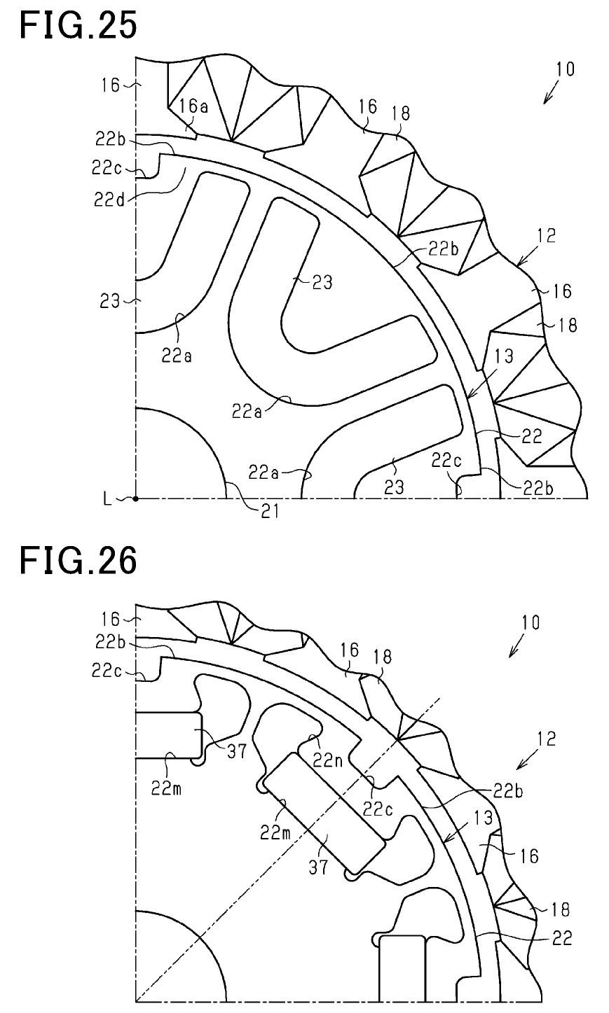

Otherwise, as shown in FIG. 26, each of the magnet-receiving portions 22m may be formed in an I-shape extending in a direction perpendicular to the radial direction; and each of the permanent magnets 37, which are received in the respective magnet-receiving portions 22m; may be arranged in an I-shape extending in a direction perpendicular to the radial direction. In this modification, the rotor 13 is of an interior permanent magnet type such that the number of the magnetic pole portions 22b and the number of permanent magnets 37 are equal to each other. Moreover, the rotor core 22 has flux barriers 22n which are air gaps for blocking magnetic flux. Specifically, in each of the magnetic pole portions 22b, there are formed two flux barriers 22n so as to respectively communicate with two ends of the magnet-receiving portion 22m. The two flux barriers 22n extend radially outward respectively from the two ends of the magnet-receiving portion 22m, thereby securing a space for forming the groove 22c on the radially outer side of the permanent magnet 37.

In the above-described embodiment, the grooves 22c are configured to open to the radially outer side of the rotor core 22. Alternatively, the grooves 22c may be replaced with holes each having a shape recessed radially inward and closed at a radially outer end thereof. That is, the grooves 22c may be replaced with other configurations which can block magnetic flux in a substantially same manner.

In the above-described embodiment, the stator core 14 is constituted of a plurality of core segments 17 such that the annular part 15 is segmented for each tooth 16. Alternatively, the stator core 14 may be formed in one piece in which the annular part 15 is not segmented.

In the above-described embodiment, the stator core 14 has twelve teeth 16 and the rotor core 22 has eight magnetic pole portions 22b. However, the number of teeth 16 and the number of magnetic pole portions 22b may be changed. That is, the number of slots and the number of magnetic poles may be changed.

While the present disclosure has been described pursuant to the above embodiments, it should be appreciated that the present disclosure is not limited to the embodiments and the structures. Instead, the present disclosure encompasses various modifications and changes within equivalent ranges. In addition, various combinations and modes are also included in the category and the scope of technical idea of the present disclosure.

The features of the present invention are summarized by the following notes.

[1] A motor (10) comprising:

an annular stator (12) having a plurality of teeth (16) each extending toward a central axis (L) and arranged in alignment with each other in a circumferential direction and windings (18) wound on the teeth; and

a rotor (13) having a rotor core (22) rotatably accommodated inside the stator and a plurality of permanent magnets (23, 32, 33, 36, 37) provided in the rotor core and arranged in alignment with each other in the circumferential direction, the rotor also having a plurality of magnetic pole portions (22b) formed by the plurality of permanent magnets on a surface of the rotor core which faces the stator and aligned with each other in the circumferential direction,

wherein:

at least some of the magnetic pole portions each have a groove (22c, 31) recessed radially inward;

in each of the at least some of the magnetic pole portions, the groove is formed symmetrically in the circumferential direction with respect to a magnetic pole center which is a circumferential center of the magnetic pole portion; and

0.12 < Wg/(360/P) < 0.31, where Wg is an angle of a width of the groove at a radially outer end thereof, and P is the number of the magnetic pole portions.

[2] The motor according to the above note [1], wherein 0.12 < Wg/(360/P) < 0.27.

[3] The motor according to the above note [1] or [2], wherein 0.7 < Wk/(2×Wr+Wg) < 1.0, where Wk is an angle of a width of each of the teeth at a radially inner end thereof, and Wr is an angle of a width of each of magnetic path portions (22d) of the rotor core which form a magnetic path on both circumferential sides of the groove.

[4] The motor according to any one of the above notes [1] to [3], wherein 0.5×Wt < Wr < Wt, where Wr is an angle of a width of each of magnetic path portions (22d) of the rotor core which form a magnetic path on both circumferential sides of the groove, and Wt is an angle of a minimum width of each of the teeth defined at a same radial position as the magnetic path portions of the rotor core.

[5] The motor according to any one of the above notes [1] to [4], wherein Z/G ≥ 0.75, where G is a length of an air gap between the teeth and the rotor core, and Z is a radial depth of the groove.

[6] The motor according to any one of the above notes [1] to [5], wherein the permanent magnets, which are provided respectively in the magnetic pole portions, are arranged in a U-shape or a V-shape which is open radially outward.

[7] The motor according to the above note [6], wherein 0.44 < Wu/(360/P) < 0.58, where P is the number of the magnetic pole portions, Wu is an angle of a width including end portions of a circumferentially-adjacent pair of the permanent magnets.

[8] The motor according to any one of the above notes [1] to [7], wherein a pair of circumferential end surfaces (31a) of the groove (31) are inclined so that the width of the groove increases radially inward.

[9] The motor according to any one of the above notes [1] to [8], wherein in each of the at least some of the magnetic pole portions, each of end portions of the permanent magnet (32) is shaped so as to recede from a corresponding one of circumferential end surfaces of the groove as it extends radially outward, and has a thick portion (32a) that protrudes in a direction approaching the corresponding one of the circumferential end surfaces of the groove.

The motor according to any one of the above notes [1] to [5], [8] and [9], wherein:

the permanent magnets (33, 36) are arranged in every other magnetic pole portion in the circumferential direction;

the plurality of magnetic pole portions include magnet magnetic-pole portions (34) each having one of the permanent magnets arranged therein and non-magnet magnetic-pole portions (35) each having no permanent magnet arranged therein;

the magnet magnetic-pole portions and the non-magnet magnetic-pole portions are arranged alternately in the circumferential direction; and

flux barriers (22h, 22k) are formed in the rotor core so as to satisfy (2×Wr1+Wg)/(2×Wr2+Wg) ≤ 1.5, where Wr1 is an angle of a width of each of magnet magnetic-path portions (22f) of the rotor core which form a magnetic path on both circumferential sides of the groove in each of the magnet magnetic-pole portions, and Wr2 is an angle of a width of each of non-magnet magnetic-path portions (22g) of the rotor core which form a magnetic path on both circumferential sides of the groove in each of the non-magnet magnetic-pole portions.

The motor according to any one of the above notes [1] to , wherein each of the teeth has a tooth groove (16b) formed at a circumferential center in a radially inner end portion thereof so as to be recessed radially outward.

The motor according to the above note , wherein Wgs-Wg < 0, where Wgs is an angle of a width of the tooth groove at a radially inner end thereof.

A motor (10) comprising:

an annular stator (12) having a plurality of teeth (16) each extending toward a central axis (L) and arranged in alignment with each other in a circumferential direction and windings (18) wound on the teeth; and

a rotor (13) having a rotor core (22) rotatably accommodated inside the stator and a plurality of permanent magnets (23, 32, 33, 36, 37) provided in the rotor core and arranged in alignment with each other in the circumferential direction, the rotor also having a plurality of magnetic pole portions (22b) formed by the plurality of permanent magnets on a surface of the rotor core which faces the stator and aligned with each other in the circumferential direction,

wherein:

at least some of the magnetic pole portions each have a groove (22c, 31) recessed radially inward or a hole having a shape recessed radially inward and closed at a radially outer end thereof; and

the motor is configured so that at a cogging peak position, the total torque generated by specific teeth, which are those of the plurality of teeth whose states of angles relative to the magnetic pole portions are identical, is within a range of 80% to 120% of cogging torque.

The motor according to the above note , wherein the motor is configured so that at the cogging peak position, the total torque generated by the specific teeth is equal to the cogging torque.

The motor according to the above note or , wherein the motor is configured so that at the cogging peak position, the total torque generated by those of the plurality of teeth other than the specific teeth is within a range of -20% to +20% of the cogging torque.

The motor according to any one of the above notes to , wherein the motor is configured so that there is an interval where the torque generated by one of the plurality of teeth remains at zero.

What is claimed is:

1. A motor comprising:
an annular stator having a plurality of teeth each extending toward a central axis and arranged in alignment with each other in a circumferential direction and windings wound on the teeth; and
a rotor having a rotor core rotatably accommodated inside the stator and a plurality of permanent magnets provided in the rotor core and arranged in alignment with each other in the circumferential direction, the rotor also having a plurality of magnetic pole portions formed by the plurality of permanent magnets on a surface of the rotor core which faces the stator and aligned with each other in the circumferential direction,
wherein:
at least some of the magnetic pole portions each have a groove recessed radially inward;
in each of the at least some of the magnetic pole portions, the groove is formed symmetrically in the circumferential direction with respect to a magnetic pole center which is a circumferential center of the magnetic pole portion; and
10.2 < Wg/(360/P) < 0.31, where Wg is an angle of a width of the groove at a radially outer end thereof, and P is the number of the magnetic pole portions.

2. The motor as set forth in claim 1, wherein 0.12 < Wg/(360/P) < 0.27.

3. The motor as set forth in claim 1, wherein 0.7 < Wk/(2×Wr+Wg) < 1.0, where Wk is an angle of a width of each of the teeth at a radially inner end thereof, and Wr is an angle of a width of each of magnetic path portions of the rotor core which form a magnetic path on both circumferential sides of the groove.

4. The motor as set forth in claim 1, wherein 0.5×Wt < Wr < Wt, where Wr is an angle of a width of each of magnetic path portions of the rotor core which form a magnetic path on both circumferential sides of the groove, and Wt is an angle of a minimum width of each of the teeth defined at a same radial position as the magnetic path portions of the rotor core.

5. The motor as set forth in claim 1, wherein Z/G ≥ 0.75, where G is a length of an air gap between the teeth and the rotor core, and Z is a radial depth of the groove.

6. The motor as set forth in claim 1, wherein the permanent magnets, which are provided respectively in the magnetic pole portions, are arranged in a U-shape or a V-shape which is open radially outward.

7. The motor as set forth in claim 6, wherein 0.44 < Wu/(360/P) < 0.58, where P is the number of the magnetic pole portions, Wu is an angle of a width including end portions of a circumferentially-adjacent pair of the permanent magnets.

8. The motor as set forth in claim 1, wherein a pair of circumferential end surfaces of the groove are inclined so that the width of the groove increases radially inward.

9. The motor as set forth in claim 1, wherein in each of the at least some of the magnetic pole portions, each of end portions of the permanent magnet is shaped so as to recede from a corresponding one of circumferential end surfaces of the groove as it extends radially outward, and has a thick portion that protrudes in a direction approaching the corresponding one of the circumferential end surfaces of the groove.

10. The motor as set forth in claim 1, wherein:
the permanent magnets are arranged in every other magnetic pole portion in the circumferential direction;
the plurality of magnetic pole portions include magnet magnetic-pole portions each having one of the permanent magnets arranged therein and non-magnet magnetic-pole portions each having no permanent magnet arranged therein;
the magnet magnetic-pole portions and the non-magnet magnetic-pole portions are arranged alternately in the circumferential direction; and
flux barriers are formed in the rotor core so as to satisfy (2×Wr1+Wg)/(2×Wr2+Wg) ≤ 1.5, where Wr1 is an angle of a width of each of magnet magnetic-path portions of the rotor core which form a magnetic path on both circumferential sides of the groove in each of the magnet magnetic-pole portions, and Wr2 is an angle of a width of each of non-magnet magnetic-path portions of the rotor core which form a magnetic path on both circumferential sides of the groove in each of the non-magnet magnetic-pole portions.

11. The motor as set forth in claim 1, wherein each of the teeth has a tooth groove formed at a circumferential center in a radially inner end portion thereof so as to be recessed radially outward.

12. The motor as set forth in claim 11, wherein Wgs-Wg < 0, where Wgs is an angle of a width of the tooth groove at a radially inner end thereof.

13. A motor comprising:
an annular stator having a plurality of teeth each extending toward a central axis and arranged in alignment with each other in a circumferential direction and windings wound on the teeth; and
a rotor having a rotor core rotatably accommodated inside the stator and a plurality of permanent magnets provided in the rotor core and arranged in alignment with each other in the circumferential direction, the rotor also having a plurality of magnetic pole portions formed by the plurality of permanent magnets on a surface of the rotor core which faces the stator and aligned with each other in the circumferential direction,
wherein:
at least some of the magnetic pole portions each have a groove recessed radially inward or a hole having a shape recessed radially inward and closed at a radially outer end thereof; and
the motor is configured so that at a cogging peak position, the total torque generated by specific teeth, which are those of the plurality of teeth whose states of angles relative to the magnetic pole portions are identical, is within a range of 80% to 120% of cogging torque.

14. The motor as set forth in claim 13, wherein the motor is configured so that at the cogging peak position, the total torque generated by the specific teeth is equal to the cogging torque.

15. The motor as set forth in claim 13, wherein the motor is configured so that at the cogging peak position, the total torque generated by those of the plurality of teeth other than the specific teeth is within a range of -20% to +20% of the cogging torque.

16. The motor as set forth in claim 13, wherein the motor is configured so that there is an interval where the torque generated by one of the plurality of teeth remains at zero.
